(19) United States
(12) Patent Application Publication
(10) Pub. No.: US 2019/0023487 A1
(43) Pub. Date: Jan. 24, 2019

(54) EXCREMENT MANAGEMENT DEVICE AND MEHTOD

(71) Applicant: Hanna Lu, Oakland, CA (US)

(72) Inventor: Hanna Lu, Oakland, CA (US)

(21) Appl. No.: 16/140,248

(22) Filed: Sep. 24, 2018

Related U.S. Application Data
(63) Continuation-in-part of application No. 15/612,776, filed on Jun. 2, 2017.

(51) Int. Cl. B65F 1/06

(52) U.S. Cl. CPC B65F 1/062

(57) ABSTRACT

A pet feces bag dispenser and carrying apparatus is provided, comprising a first portion having a first hexagonal truncated pyramid with six faces forming a first open base of the first hexagonal pyramid, the faces are planar walls having a thickness extending upward from the base to a top plane having an opening at the top of the first hexagonal pyramid. a second portion having a second hexagonal truncated pyramid shape with six faces forming a second open base, the six faces of the second hexagonal pyramid are planar second walls having a second thickness extending downward from the second base including a solid bottom plane formed at a common top edge of the second walls. Two axles affixed at opposing points on inner surfaces of the first portion enabled to hold a roll of feces bags,. The first and second bases come together in a closed position.

### CROSS-REFERENCE TO RELATED DOCUMENTS

The present invention is a continuation-in-part (CIP) to a U.S. patent application Ser. No. 15/612,776 entitled Excrement Management Device and Method filed on Jun. 6, 2017, disclosure of which is incorporated herein.

### BACKGROUND OF THE INVENTION

### 1. Field of the Invention

The present invention is in the field of aftermarket pet products and pertains particularly to methods and apparatus for managing pet excrement while engaged in walking or otherwise monitoring the pet.

### 2. Discussion of the State of the Art

Walking a dog is one of Americas favorite pastimes. Dog walkers that frequent walking trails, dog parks, beaches, and other areas where walking dogs is permitted are expected to clean up their dog's excrement during their time in the area. Some folks carry loose bags and a scoop or pick-up tool for cleaning up after their dogs. Some jurisdictions provide doggie bag dispensers and trash receptacles for people to dump their dog excrement.

One challenge with current expectations and available provisions is that they are not consistent from area to area, for example some trails offer nothing to aid in cleaning up dog excrement and expect the user to bring the utensils. Another challenge is that many dog owners who walk their dogs are not fond of handling dog excrement and really do not want to have to carry the bagged excrement until their walk is over or until they find a trash receptacle.

Therefore, what is clearly needed is a system that enables excrement management in a way that is both convenient and fashionable.

### BRIEF SUMMARY OF THE INVENTION

One embodiment of the preset invention provides a pet feces bag dispenser and carrying apparatus comprising a first portion having a first hexagonal truncated pyramid with six faces forming a first open base of the first hexagonal pyramid. The faces may be planar walls having a thickness extending upward from the base to a top plane having an opening at the top of the first hexagonal pyramid, thereby forming a first inner open volume.

In this embodiment, a second portion having a second hexagonal truncated pyramid shape with six faces forming a second open base is provided. The six faces of the second hexagonal pyramid are planar second walls having a second thickness extending downward from the second base opening thereby forming a second inner open volume including a solid bottom plane formed at a common top edge of the second walls.

One embodiment may include two axles affixed at opposing points on inner surfaces of the first portion enabled to hold a roll of feces bags, and an end of the roll constituting a single bag connected to the roll of bags extends up through the opening.

This embodiment may provide that the first and second bases come together in a closed flush position wherein a bottom edge of each of the walls are aligned and fixed together with a hinged side opposite a means for keeping the first and second bases adhered together in the closed position.

In this embodiment the first inner volume may be less than the second inner volume. Additionally, the opposing points may be located at a third thickness formed at an intersection of two of the faces, the third thickness greater than the first and second thickness. Additionally, an alternative embodiment provides that an interface wall is formed, horizontal and planar, between the roll of feces bag and the opening, the interface wall having a slit opening allowing the single bag to be fed through the slit and out through the opening.

An additional embodiment provides that multiple slits may be positioned to extend away from a midpoint spherical opening in the interface wall. A latch interface may be included which is molded into an outer surface of the first portion accepting a latch connected to a second apparatus or a user via a loop, tether or belt.

One embodiment provides a method for dispensing feces bags and carrying feces, comprising steps for providing a first portion having a first hexagonal truncated pyramid with six faces forming a first open base of the first hexagonal pyramid. The faces may be planar walls having a thickness extending upward from the base to a top plane having an opening at the top of the first hexagonal pyramid, thereby forming a first inner open volume.

An additional step provides a second portion having a second hexagonal truncated pyramid shape with six faces forming a second open base, the six faces of the second hexagonal pyramid are second planar walls having a second thickness extending downward from the second base opening thereby forming a second inner open volume including a solid bottom plane formed at a common top edge of the second walls. in this embodiment, two axels may be fixed at opposing points on inner surfaces of the first portion holding a roll of feces bags, and extending an end of the roll constituting a single bag connected to the roll of bags up through the opening.

Finally, in this embodiment, a bottom edge of each of the walls join in an aligned position via a hinge positioned at a side opposite a means for keeping the first and second bases adhered together in the closed position.

### BRIEF DESCRIPTION OF THE SEVERAL VIEWS OF THE DRAWINGS

FIG. 1 is a front elevation view of a pet feces carry bag according to an embodiment of the present invention.

FIG. 2 is a rear elevation view of the carry bag of FIG. 1.

FIG. 3 is a perspective view of the carry bag of FIG. 1 depicted in an open state.

FIG. 4 is an overhead view of the carry bag of FIG. 1 with a clasp and loop attached for carry convenience.

FIG. 5 is an overhead view of the carry bag of FIG. 1 with the top material portion removed to depict internal components.

FIG. 6 is a process flow chart depicting steps for using a pet feces carry bag according to an embodiment of the present invention.

FIG. 7 is a perspective view of a pet feces carry bag according to another embodiment of the present invention.

FIG. 8 is an overhead perspective view of the pet feces carry bag of FIG. 7 open depicting internal space.

### DETAILED DESCRIPTION OF THE INVENTION

In various embodiments described in enabling detail herein, the inventor provides a unique system for managing pet excrement while walking or otherwise monitoring one or more pets. More particularly, he inventor provides a pet feces carry bag or pouch that reduces the work and smell relative to dealing with dog feces, for example, while walking a dog. The present invention is described in enabling detail using the following examples, which may describe more than one relevant embodiment falling within the scope of the present invention.

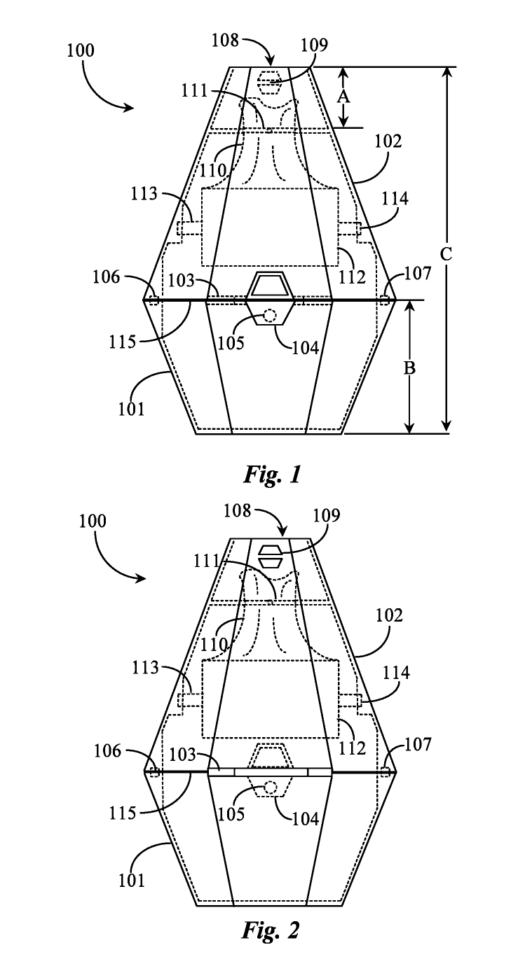

FIG. 1 is a front elevation view of a pet feces carry bag 100 according to an embodiment of the present invention. Feces carry bag 100, is trade named a koodini bag by the inventor, however in this specification carry bag 100 shall be referred to as a carry bag for carrying or transporting pet feces to a suitable waste receptacle. Carry bag 100 may be molded or otherwise fabricated out of a semi flexible silicone material. Other materials may also be substituted therefor, however silicone is chemically resistive, somewhat flexible and is a durable material. Other materials may include plastic or even a flexible metal.

Carry bag 100 has two main bag portions including a base portion 101 and a top portion 102. In this embodiment carry bag 100 is fabricated or molded in the shape comprising two hexagonal pyramids that align and meet at the bases of the two hexagonal pyramids, or similar to a six sided gem stone where the “girdle” (widest horizontal plane) of the stone or in this case bag, is also the cut line or interface 115 separating the top and base portions of the bag. That is to say the conical top and conical bottom portions 102 and 101 fit together dimensionally and relative to alignment of the six sides of each portion for opening and closing the bag. Top portion 102 and base portion 101 may be completely separate or separated parts (after molding) and may be hinged along one facet with a hinge element 103. Hinge 103 may be a metal or plastic hinge supplied and fastened to carry bag 100 or may be molded or otherwise may be contiguously part of the material of the bag.

Carry bag 100 may be semi-flexible and may have areas or portions where wall thickness of the bag is greater than average to support mounting of components needed to enable the functions of carry bag 100. Base portion 101 and top portion 102 are held together in a closed state via magnetic interfaces and a magnetic latch. In this example a right-side magnetic interface 106 is provided and mounted within an area of thicker material to provide land space for the mechanism. A left side magnetic interface 107 is similarly provided. Magnetic interfaces 106 and 107 may consist of two opposing earth magnets aligned to attract or one magnet and a magnetic button. A magnetic latch 104 includes an opposing magnetic interface 105. In this way a user may open and close the feces carry bag with minimal force or work but the magnets hold the bag closed when transporting feces within the bag. Other means for fastening may be implemented in other embodiments such as a mechanical latch or snap arrangement.

Carry bag 100 is adapted to enable storage of and manual dispensing of one or more feces bags 110 dispensed from a bag roll 112. Roll 112 may have a number of plastic feces bags such as feces bag 110 stored thereon and connected bag-to-bag by perforation (not illustrated) so that a single bag such as bag 110 may be easily separated from a bag roll such as roll 112. A bag separation interface 111 is provided and disposed horizontally above roll 112 and may include a standard bag separator flap interface such as those found on containers of cleaning towels or the like. Bag separator interface may be fabricated of a semi flexible plastic or other polymer composite materials. In another embodiment the bag separation interface 111 is not required to practice the present invention.

Bag roll 112 may be axially mounted within top portion 102 of carry bag 100 using axle rods such as a right side axle rod 113 and a left side axle rod 114 having connection to the substantial center of roll 112 at either end and having mounting ends that may be mounted or otherwise installed into the areas of thicker material provided in the molding process for this purpose. In one embodiment, axle rods 113 and 114 may instead be a single axle running all of the way through the roll and are mounted at the opposing walls of the top portion of the carry bag. Axle rods 113 and 114 may be fabricated of plastic or other resilient materials.

Top portion 102 of carry bag 100 includes a central top opening 108 that is sufficient in size to enable a user to reach in with their fingers to retrieve some feces bag without opening the carry bag. A small compartment having a depth of A is defined between the bag separation interface 111 and the top of the carry bag. The mentioned compartment may store or conceal a leading portion of a next bag 110 that has been threaded through the bag separation interface 111. The threaded separation interface is advantageous in that when a full feces bag is stored in lower portion 101, any smell emanating from the full bag is diminished or otherwise is contained within bag 100.

In one embodiment a lid or cover (not illustrated) may be placed over the top of carry bag 100 to cover opening 108, but it is not required in order to practice the present invention. The depth of base portion 101 of carry bag 100 is defined by a dimension B. In one embodiment, dimension B may be varied from carry bag to carry bag such as provision of a deeper base in order to hold more dog feces bags containing feces such as from a larger or more than one dog. Some carry bags may have a shallower base portion for smaller dogs such as a Chihuahua. Dimension C represents the overall height of the entire carry bag and might be different (larger or smaller) depending upon what dimension B may be.

Roll 112 may be freely rotatable or governed by a friction brake mechanism (not illustrated). Roll 112 may be removable from its seat within top portion 102 of carry bag 100 to enable replacement of a new feces bag roll when bags run out. Base portion 101 of carry bag 100 is hollow with no components occupying the space defined. Therefore, pet feces bags that may have pet feces in them may be tied off and stored within the compartment. The only time carry bag 100 is required to be opened is to replace bag roll 112, place a feces bag into the base compartment or to take one out of the compartment for trash disposal into a standard waste receptacle such as a garbage can or dedicated feces receive station or box.

Top portion 102 of carry bag 100 includes a latch interface 109 molded into the material or otherwise formed therein for the purpose of accepting a latch connected to such as a wrist loop or belt tether or some other tether device for securing the carry bag onto a user or onto the clothing of a user such that the user does not have to carry the item while walking a dog.

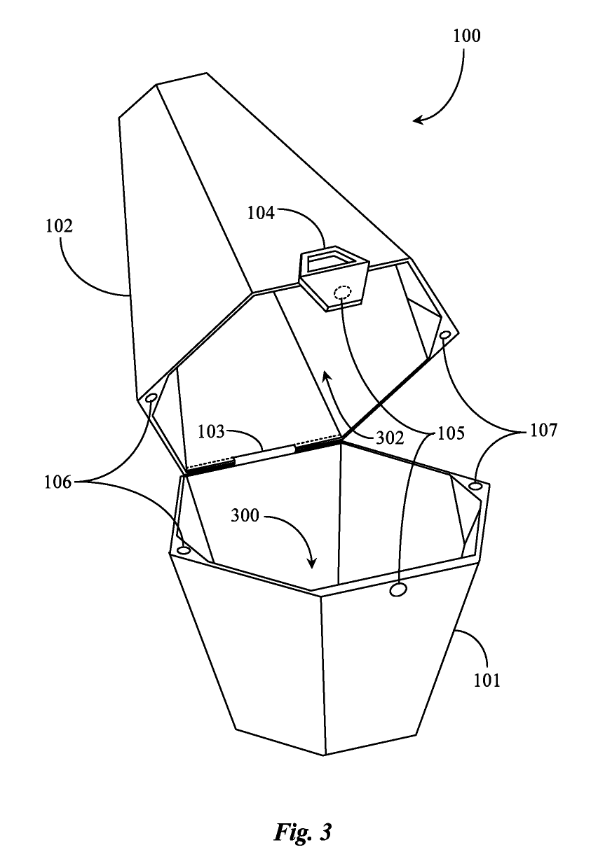

FIG. 2 is a rear elevation view of carry bag 100 of FIG. 1. Carry bag 100 is rotated 180 degrees to reveal the rear of the device. In this example, carry bag 100 is hinged at the rear facet opposite of magnetic latch 104. Latch interface 109 is provided on the rear side as well for convenience in opening the carry bag without latch or tether obstruction of the main opening for retrieval of or placement of a feces bag into the carry bag.

Carry bag 100 may be available in many different colors that may include highly visible neon colors and glow in the dark materials, so it may be highly visible during low light conditions. In one embodiment, carry bag 100 may be latched to a dog leash or collar without departing from the spirit and scope of the present invention. Bags 110 may be thin but resilient plastic pet feces bags that, for example, might be 6″×10″ or 9″×13″ bags for example. The bags may be folded and perforated on roll 112, wherein roll 112 may be only between 2″ to 3″ inches wide. In one embodiment, bag ties (not illustrated) may be provided and carried within carry bag 100 such as within base portion 101 so that the feces bags need not be tied over themselves.

FIG. 3 is a perspective view of carry bag 100 of FIG. 1 depicted in an open state. In this view, carry bag 100 is open at the girdle interface 115 by using a minimal force to separate magnetic mechanisms 106 and 107 and latch mechanism 105. In other embodiments another mechanism might be used to secure the top portion and base portion together such as a snap mechanism or fabric mechanism, etc. Hinge 103 is visible at rear of carry bag 100. Compartment 300 is visible and accessible whenever a user open carry bag 100.

Nothing occupies compartment 300 with the exception of a feces bag such as a deployed one of bags 110 that may be placed within the compartment for carry. However, items of interest such as a dog whistle, ties for feces bags, or the like may also be transported and or stored within carry bag 100. A middle compartment 302 is defined within top portion 102 of and contains the roll 112 of feces bags disposed horizontally (not visible here). In one embodiment hinge 103 enables a 180-degree swing in opening the carry bag. Latch 104 may be fabricated of rubber, silicone or a flexible but resilient plastic. Magnetic interfaces 106 and 107 may be press fit into recesses that are deep enough to render the top surfaces of the magnets or magnetic buttons if any flush or just shy of flush with the respective surfaces. In this way the surfaces defining a cut line of interface 115 may make intimate contact with no gap formed allowing for better order protection when feces are carried or are in tow. A smell cover may also be provided for the top opening (108) if desired.

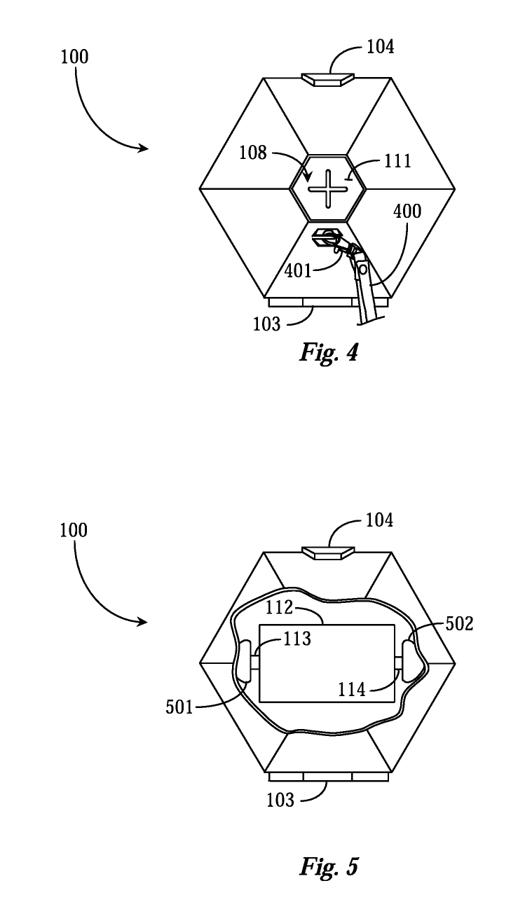

FIG. 4 is an overhead view of carry bag 100 of FIG. 1 with a clasp and loop attached for carry convenience. In this example, opening 108 exposes bag separator interface opening 111. Interface 111 is formed as a wall formed horizontally at some depth below opening 108 where the interface open portion of the wall (cross shape in center) is positioned to accept a feces bag threaded there through from below and to present the bag end within the created space. When a bag is fully pulled out the user may snap off the bag along the perforations.

In this example, a latch and loop device 401 such as a wrist loop 400 may be attached to latch interface 109 via a traditional style latch mechanism or a carabiner mechanism. This latch and loop device 400 may enable a user to carry the container on the wrist, about the neck, clipped onto clothing or a pack, etc. In one embodiment the user may attach the carry bag directly to a dog leash where it may hang along with tags, etc., or on to the collar of the animal or onto a harness that animal may be wearing.

FIG. 5 is an overhead view of carry bag 100 of FIG. 1 with a top material portion removed to depict internal components. Feces bag roll 112 rests just below the bag separation interface wall of FIG. 4. Material including the interface 111 is removed in this view for clarity. In this example, a right-side axle rod seat 501 is provided and mounted to the wall of compartment (302) and in line with a left side axle rod seat 502 mounted on the opposing wall. In one embodiment axle rod seats are metallic and spring loaded and may accept and retain an axle rod by clipping onto and over the diameter of the rod.

In another embodiment axle rod seats may be formed during the molding process. In one embodiment the axle rod seats may be adapted to accept a slightly wider diameter and then snap back to nominal diameter thereby retaining the axle rod. This is accomplished in an embodiment wherein the bag 100 is made of silicon or other rigid, yet flexible material. When two opposing sides forming a cross section intersecting a linear path formed by the two axles are compressed a diameter between the two axles increases and a new bag roll 112 can easily be inserted and aligned with axles 113 and 114. When the two opposing sides are then released the axles snap closer together, decreasing the diameter and engaging an inner tunnel formed at the center of bag roll 112.

In still another embodiment the axle rod may be a spring tensioned tube assembly like a toilet paper axle that can be compressed in at the ends to install roll 112 in the provided seats in the walls of the carry bag.

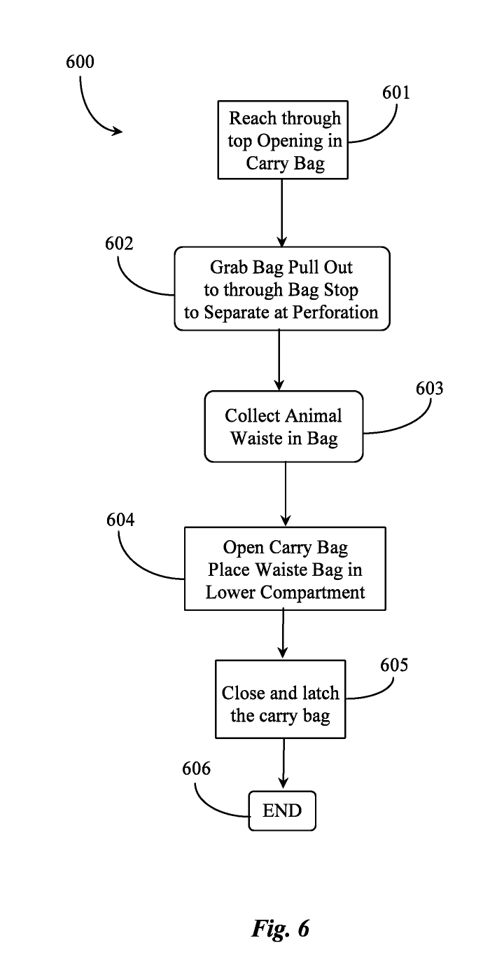

FIG. 6 is a process flow chart 600 depicting steps for using pet feces carry bag 100 according to an embodiment of the present invention. At step 601, a user may reach through the top opening in the carry bag to grasp a bag end at step 602 that has been threaded through the bag separation interface previously such as in the process of bag dispensing and to separate the bag with the aid of the bag separation interface 111. The bags separate at the perforations.

At step 603, the user proceeds to collect animal waist, typically dog feces, into the bag. In this process the user may put her hand inside the bag and pick up the feces with the bag and then peel the back off of the writs to bag and contain the feces. This prevents any dog feces from getting onto the outside of the bags. In other situations, a scoop or other tool may be used to grab and then place the feces into the feces bag.

At step 604 the user may open the carry bag by using minimal force to separate the magnetic holds keeping the bag closed and may place the feces bag with dog feces inside into the base compartment of the carry bag. The user may tie the bag clip the bag or otherwise seal the bag from the environment in the same step or just before placement of the bag. At step 605, the user may then close and latch the carry bag with the feces held within in a secure manner.

The user may leave the feces inside the carry bag until the user finds or otherwise discovers a receptacle to dump it in, in which case the process is reverse of placement. If the user has larger dogs, she may use the carry bag with the larger base portion providing more depth. If the user has a smaller dog, then she may use the carry bag having the shortest base portion. In one embodiment these are attachable to a top portion so that one may interchange the bases portion depending upon predictive need. In one embodiment the user may select a color that matches a particular fashion the user is wearing that day and may have several different color bags to choose from. In still another embodiment the carry bag may be a neutral color while the user may have multiple and different colored jackets that might be placed around of otherwise fitted over the carry bag to accessorize the product as a fashionable item. In this aspect the fashion may also extend to the dog relative to dog apparel, leash color, etc.

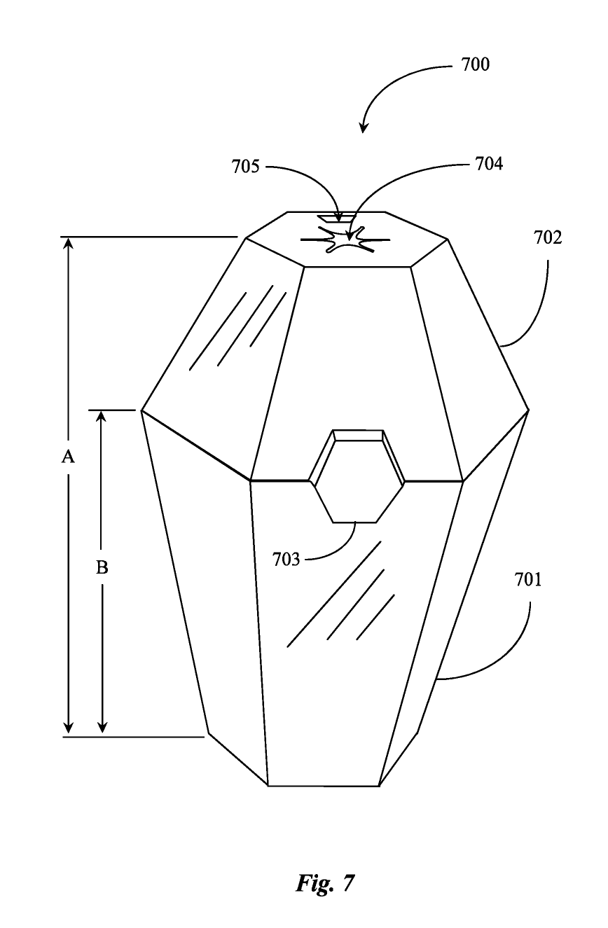

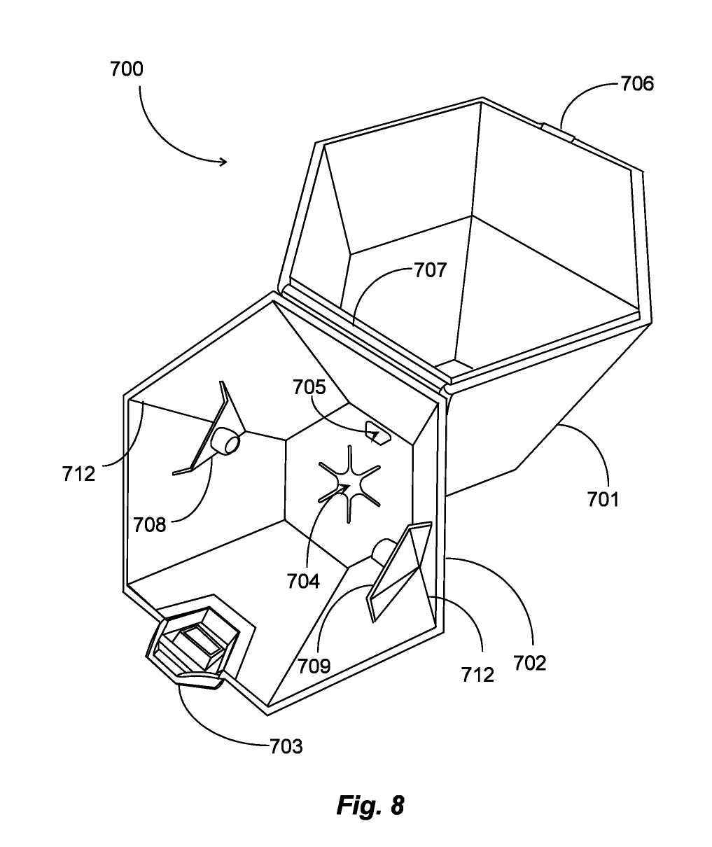

FIG. 7 is a perspective view of a pet feces carry bag 700 according to another embodiment of the present invention. Feces carry bag 700, may be molded or otherwise fabricated out of a semi flexible silicone material. Other materials may also be substituted therefor, however silicone is chemically resistive, somewhat flexible and is a durable material. Other materials may include plastic or even a flexible metal.

Carry bag 700 has two main bag portions including a base portion 701 and a top portion 702. In this embodiment, carry bag 700 is fabricated or molded in the shape comprising two hexagonal pyramids that align and meet at the bases of the two hexagonal pyramids, or similar to a six sided gem stone where the “girdle” (widest horizontal plane) of the stone or in this case bag, is also the cut line or interface separating the top and base portions of the bag as described relative to carry bag 100 FIG. 1. Top portion 702 and base portion 701 may be separate or separated parts (after molding) and may be hinged along one facet with a hinge element (not depicted here).

In this embodiment, feces carry bag 700 has and overall height dimension expressed as height A. Height dimension A may be about 6 inches nominally. The height dimension for base portion 701 of feces carry bag 700 is expressed as height B. In this embodiment the base height B is expressed as approximately two thirds of the total height A. Therefore, if A is six inches in height than B is four inches of height. The logic for the ratio between the components is that the bag roll spindle hardware does not require much space to be mounted so by extending the base height, the inventor provides more room in the base portion of the feces bag to carry more feces. In all embodiments, the pet feces carry bag or Koodini as termed by the inventor, may be provided in a larger size for larger animals and a smaller size for smaller animals without departing from the spirit and scope of the present invention.

In this embodiment, an opening 705 is provided through the top surface of top portion 702 of feces carry bag 700. The interface is for attachment of a strap, belt clip, or a carabiner. In this embodiment, a bag opening 704 is provided through the top surface of the top portion 702 of feces carry bag 700. Opening 704 has more flexibility than the four-point bag opening 108 depicted in FIG. 4 and therefore allows better access to the feces bag feeder roll. The bags are linearly attached via perforation and opening 704 provides a grab interface to break the perforations upon physical shear force performed by the user when separating a bag to use. In this embodiment, feces carry bag 700 includes a magnetic clasp handle 703 that has a six-sided geometry and at least one embedded magnet to interface with a second embedded magnet in the interfacing wall surface of the base portion 701.

FIG. 8 is an overhead perspective view of pet feces carry bag 700 of FIG. 7 open depicting internal space. Feces carry bag 700 has a nominal wall thickness that is uniform throughout the component both in the top portion 702 and in the base portion 701. Top portion 702 includes a clasp interface location 706, more particularly the area that will interface clasp handle 703. It is noted herein that an embedded rectangular magnet 710 is provided and may be set in the surface of the interfacing edge of the top portion of the feces carry bag 700 opposite hinge element 707 and substantially centered between adjacent point representing corners of the top portion.

Clasp handle 703 includes an embedded magnet 711 to interface with magnet 710 when feces carry bag 700 is in the closes position. A magnet clasp handle such as 703 may be provided of other shapes without departing from the spirit and scope of the present invention. Feces carry bag 700 includes opposing bag spindle mounts 708 and 709 that may be formed contiguously with the molding of the top portion 702.

Spindle mounts 708 and 709 may be welded to respective inner walls or glued to respective inner walls using a positioning fixture and a polymer weld or glue technique without departing from the spirit and s cope of the present invention. The requirement of having thicker walls for supporting a stock roller axle is obfuscated by fixtures 708 and 709. A bag roller may be spring loaded, so it may be collapsed in length to fit onto spindle mounts 708 and 709. In this embodiment, spindle mounts 708 and 709 are each centered over opposing acute angle forming the hexagon of the top portion. The design adhering to the base portion thereof being held at two thirds of the overall height dimension provides extra space for storing feces bags full of feces such as when a dog walk is longer, or the dog is larger or more active in creating excrement.

It will be apparent to one with skill in the art that the feces carry bag system of the invention may be provided using some or all the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will further be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented within the scope of the invention. The invention is limited only by the breadth of the claims below.

1. A pet feces bag dispenser and carrying apparatus, comprising:
a first portion having a first hexagonal truncated pyramid with six planar walls forming a first open base of the first hexagonal pyramid, the planar walls having a thickness extending upward from the base to a top plane having an opening at the top of the first hexagonal pyramid, thereby forming a first inner open volume;
a second portion having a second hexagonal truncated pyramid shape with six planar second walls forming a second open base, the planar second walls having a second thickness extending downward from the second base opening thereby forming a second inner open volume including a solid bottom plane formed at a common top edge of the second walls; and
two axles affixed at opposing inner surfaces of the first portion enabled to hold a roll of feces bags, and an end of the roll constituting a single bag connected to the roll of bags extends up through the opening;
wherein the first and second bases come together in a closed position wherein a bottom edge of each of the first and second walls are aligned and fixed together with a hinged side opposite a means for keeping the first and second bases adhered together in the closed position.

2. The apparatus of claim 1, wherein the first inner volume is less than the second inner volume.

3. The apparatus of claim 1, wherein each one of the axles are attached to a spindle mount attached at opposing areas of an inner surface of the first portion, the opposing areas are at an acute angle intersection of two of the first walls.

4. The apparatus of claim 3, wherein a single axle having a first and second end is inserted through the roll.

5. The apparatus of claim 4, wherein the opening is formed by multiple slits extending away from a midpoint spherical opening.

6. The apparatus of claim 1, wherein a latch interface is molded into an outer surface of the first portion accepting a latch connected to a second apparatus or a user via a loop, tether or belt.

7. A method for dispensing feces bags and carrying feces, comprising steps for:
(a) providing a first portion having a first hexagonal truncated pyramid with six faces forming a first open base of the first hexagonal pyramid, the faces are planar walls having a thickness extending upward from the base to a top plane having an opening at the top of the first hexagonal pyramid, thereby forming a first inner open volume;
(b) providing a second portion having a second hexagonal truncated pyramid shape with six faces forming a second open base, the six faces of the second hexagonal pyramid are second planar walls having a second thickness extending downward from the second base opening thereby forming a second inner open volume including a solid bottom plane formed at a common top edge of the second walls;
(c) fixing two axles at opposing points on inner surfaces of the first portion holding a roll of feces bags, and extending an end of the roll constituting a single bag connected to the roll of bags up through the opening;
(d) connecting a bottom edge of each of the walls in an aligned position via a hinge positioned at a side opposite a means for keeping the first and second bases adhered together in the closed position.

8. The method of claim 7, wherein the first inner volume is less than the second inner volume.

9. The method of claim 7, wherein each one of the axles are attached to a spindle mount attached at opposing areas of an inner surface of the first portion, the opposing areas are at an acute angle intersection of two of the first walls.

10. The method of claim 9, wherein a single axle having a first and second end is inserted through the roll.

11. The apparatus of claim 7, wherein the opening is formed by multiple slits extending away from a midpoint spherical opening.

12. The method of claim 7, wherein a latch interface is molded into an outer surface of the first portion accepting a latch connected to a second apparatus or a user via a loop, tether or belt.
